(19) United States
(12) Patent Application Publication
(10) Pub. No.: US 2008/0033797 A1
(43) Pub. Date: Feb. 7, 2008

(54) SEARCH QUERY MONETIZATION-BASED RANKING AND FILTERING

(75) Inventors: David M. Chickering, Bellevue, WA (US); Christopher A. Meek, Kirkland, WA (US); Kumar H. Chellapilla, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/461,552

(22) Filed: Aug. 1, 2006

(51) Int. Cl. G06Q 30/00

(52) U.S. Cl. 705/14

(57) ABSTRACT

Advertiser monetization information is utilized to determine a search query monetization value that can be employed in web-search ranking to facilitate in ranking search results and/or in email spam filtering to reduce unsolicited emails and the like. Various methods can be employed to filter and/or rank and the like based on the search query monetization value. This can include biasing based on high values and/or low values. The search query monetization value can be determined based on, for example, independent phrases and/or bids. In other instances, personal user advertising interactions can be employed as well to facilitate search result ranking and/or email spam filtering. Employment of search query monetization value techniques can substantially reduce various types of subversive/undesired information.

### BACKGROUND

The Internet has become widely utilized as an advertising means for businesses. Search engines, in addition to providing results for user queries, also serve advertisements alongside the search results. The advertisements served are related to the search query. The more relevant the advertisements are to the user's intent and the query, the more the added value to the user, the businesses, and the search engine. However, the high amounts of revenue generated by interactions with advertisements have also spawned many to attempt to hijack or redirect users to their websites or advertisements instead of the destinations desired by users. These types of subversive diversions are typically executed by providing false information to web crawlers/bots that search the Internet for web site content. This deception is often referred to as “web spam” because users are redirected to undesired web sites. Web spam is somewhat similar to email spam which is also unsolicited information/advertisements that are sent to users. Spam in general is the electronic equivalent of traditional junk mail.

Due to the nature of spam and the pure volume thereof, spam is considered a nuisance that inconveniences users and creates user frustration. Not only do users waste time sorting through a deluge of undesired information, but they also likely bear the costs of the tremendous amounts of resources (e.g., storage space, network bandwidth, faster processors, . . . ) required to cope with various forms of spam (e.g., irrelevant search results, email advertisements, etc.). A variety of systems and techniques have been developed and employed to combat spam in both the Web and email, often requiring numerous filtering processes. Once identified, action is taken on the content such as redirection to a designated location (e.g. spam folder, quarantine region . . . ) and/or deletion, etc. However, the traditional filtering methods frequently fall far short of adequately eliminating undesired spam.

### SUMMARY

Advertiser monetization information is leveraged to substantially reduce subversive and/or undesired information (i.e., spam). This can be utilized to enhance search query results and/or eliminate nuisance emails and the like. The advertiser monetization information is utilized to determine a search query monetization value that can be employed by, for example, search engines to facilitate in ranking search results and/or in email spam filters to reduce unsolicited emails. Various methods can be utilized to filter and/or rank and the like based on the search query monetization value. This can include biasing based on high values and/or low values. The search query monetization value can be determined based on, for example, independent phrases and/or bids. In other instances, personal user advertising interactions can be employed as well to facilitate search result ranking and/or email spam filtering. Employment of search query monetization value techniques can substantially reduce various types of subversive/undesired information, dramatically increasing user satisfaction (e.g. less email spam to deal with and/or better search relevancy results, etc.) and spam blocking and/or search engine credibility.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of an advertiser monetization-based search query evaluation system in accordance with an aspect of an embodiment.

FIG. 2 is another block diagram of an advertiser monetization-based search query evaluation system in accordance with an aspect of an embodiment.

FIG. 3 is a block diagram of a search relevance improvement system in accordance with an aspect of an embodiment.

FIG. 4 is a block diagram of an email spam reduction system in accordance with an aspect of an embodiment.

FIG. 5 is a flow diagram of a method of determining advertiser-monetization values for search queries in accordance with an aspect of an embodiment.

FIG. 6 is a flow diagram of a method of utilizing search query monetization values to improve search relevance in accordance with an aspect of an embodiment.

FIG. 7 is a flow diagram of a method of utilizing search query monetization values to filter spam emails in accordance with an aspect of an embodiment.

FIG. 8 illustrates an example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

Web-search engines typically make money by showing advertisements above and/or to the side of the non-monetized (i.e., organic) results. Advertisers compete with each other in an auction to decide which advertisements are shown. In the most common pricing model, an advertiser pays the search engine each time his advertisement is clicked by the person doing the search. Search engines can log, for each query, all of the monetization information for that query, such as: how many bidders were competing, what were the bids, how much was charged, etc. Instances disclosed herein utilize the monetization information to facilitate in reducing the effects of spam. In general, an indication of how valuable a particular search query is can be obtained by looking at the monetization information—search queries for which advertisers are willing to pay a lot of money are also likely to be targets of spammers. Other instances also incorporate specific user advertising interactions to tune the effect based on individual users.

For example, search relevance can be compromised by web spam. Web spammers try to trick search engines into showing particular pages higher up in the result set than those pages deserve. One such web-spam trick is to embed hidden words in the html of a web page that might suggest to a ranking algorithm that the page is more relevant than it really is. Similarly, communications can be compromised by email spam. Email spammers overwhelm email systems with large quantities of unsolicited emails every day. Some spammers even attempt to camouflage the true content of the spam emails and/or the true sender of the email to entice recipients to open their spam emails. Thus, instances provided herein can utilize data collected from a search advertising system to help rank organic (non advertisement) search results, to help filter email spam, and/or to facilitate in providing “user-specific” results and/or filtering based additionally on specific user impressions/clicks/purchases and the like.

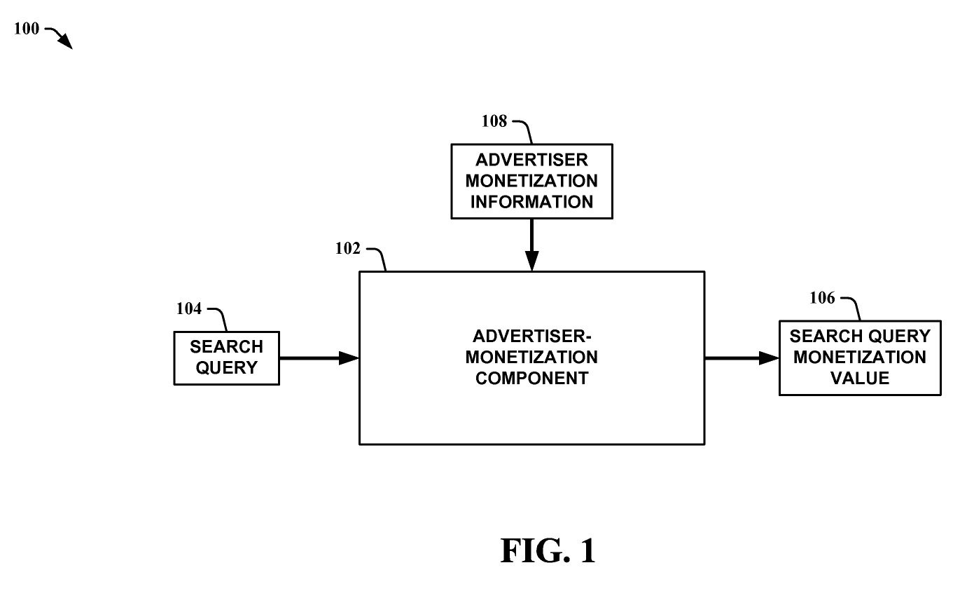

In FIG. 1, a block diagram of an advertiser monetization-based search query evaluation system 100 in accordance with an aspect of an embodiment is shown. The advertiser monetization-based search query evaluation system 100 is comprised of an advertiser-monetization component 102 that receives a search query 104 and provides a search query monetization value 106 based on advertiser monetization information 108. The advertiser-monetization component 102 can employ different search query monetization maps for establishing the search query monetization value 106. Examples of these mapping techniques are discussed in more detail infra. The advertiser monetization information 108 is typically collected from search engine logs and/or advertising systems and can include, but is not limited to, such information as how many bidders were competing for a search query, what the bids were, and/or how much was charged and the like.

For example, a user who enters the term “flower” into a search engine may also be interested in purchasing flowers as well as finding out further information about a flower—thus, it is beneficial for a company that sells flowers to advertise to that user at the point in time that the user is searching for a relevant term. Thus, frequently, users who are searching for information will see related advertisements and click on such advertisements to purchase flowers, thereby creating business for the flower retailer. The search engine itself is also provided with additional revenue by selling advertisement space for a particular period of time to a retailer when a relevant term, such as, for example, the term “flower,” is utilized as a search term.

The advertising space relating to search terms is typically bought or sold in an auction. More specifically, a search engine can receive a query (from a user) that includes one or more search terms that are of interest to a plurality of buyers. The buyers can place bids with respect to at least one of the search terms, and a buyer that corresponds to, for example, the highest bid will have their advertisement displayed upon a resulting page view. The search engine stores this advertising information in logs so that it can track which advertisers bid, how much they bid, and for what search terms, etc. The advertiser monetization information 108 can also be obtained in substantially real-time and/or from a local and/or remote data store.

The search query monetization value 106, in effect, represents the commercial desirability or worth of the search query 104. Because spammers tend to target highly desirable search queries, the search query monetization value 106 is a good indicator of likely spammer targets. Thus, the search query monetization value 106 can be leveraged to facilitate in, for example, improving organic search relevance and/or reducing spam emails and the like as described in detail infra. This affords a substantial improvement over current spam reduction techniques.

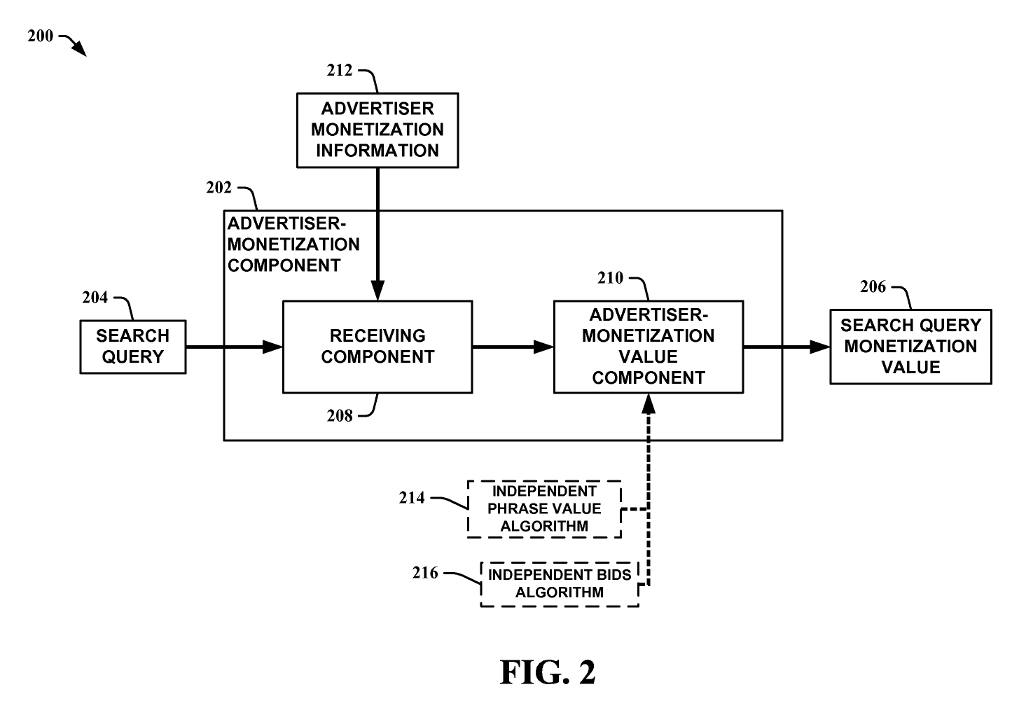

Turning to FIG. 2, another block diagram of an advertiser monetization-based search query evaluation system 200 in accordance with an aspect of an embodiment is depicted. The advertiser monetization-based search query evaluation system 200 is comprised of an advertiser-monetization component 202 that receives a search query 204 and provides a search query monetization value 206. The advertiser-monetization component 202 is comprised of a receiving component 208 and an advertiser-monetization value component 210. The receiving component 208 receives the search query 204 and obtains advertiser monetization information 212. In other instances the advertiser monetization information 212 can be directly obtained by the advertiser-monetization value component 210. The receiving component 208 relays the search query 204 and/or the advertiser monetization information 212 to the advertiser-monetization value component 210.

The advertiser-monetization value component 210 determines the search query monetization value 206 based on, at least in part, the advertiser monetization information 212. To facilitate the determination, the advertiser-monetization value component 210 can employ, for example, monetization value mapping processes that employ, for example, independent phrase value algorithm 214 and/or independent bids algorithm 216 and the like. These two mapping algorithms are not the only algorithms that can be utilized with instances described herein. It can be appreciated that there are many acceptable ways to map from monetization information to the monetization value of a search query.

Two simple algorithms mentioned above that can be employed are described in detail. In a first example, independent phrase values are utilized. For each search query that occurs during some time span (e.g., a day), calculate the total amount charged to advertisers. Distribute this amount uniformly among phrases in the search query 204 (a phrase can be a single word and/or multiple words). When a new search query comes in, the advertiser-monetization value component 210 can sum up the phrase values to determine the search query monetization value 206. For example:

| | |
|---|---|
| Search Query #1: “digital camera” | Total Charged: $120 |
| Search Query #2: “where is the camera store” | Total Charged: $100 |

Phrase Values:

“digital” = $120/2 = $60
“camera” = $120/2 + $100/5 = $80
“where” = $100/5 = $20

In a second example, independent bids are utilized. For each search query that has occurred, record the third-highest (or second-highest, or . . .) bid for a click on that search query. As in the independent phrase value example above, distribute this bid uniformly across the phrases in the search query 204, and store with each phrase the average “phrase bid” attributed to the phrase when it appears in a search query that has at least one advertisement. When a new search query comes in, the advertiser-monetization value component 210 takes the average (or the sum) of the individual phrase bids to determine the search query monetization value 206.

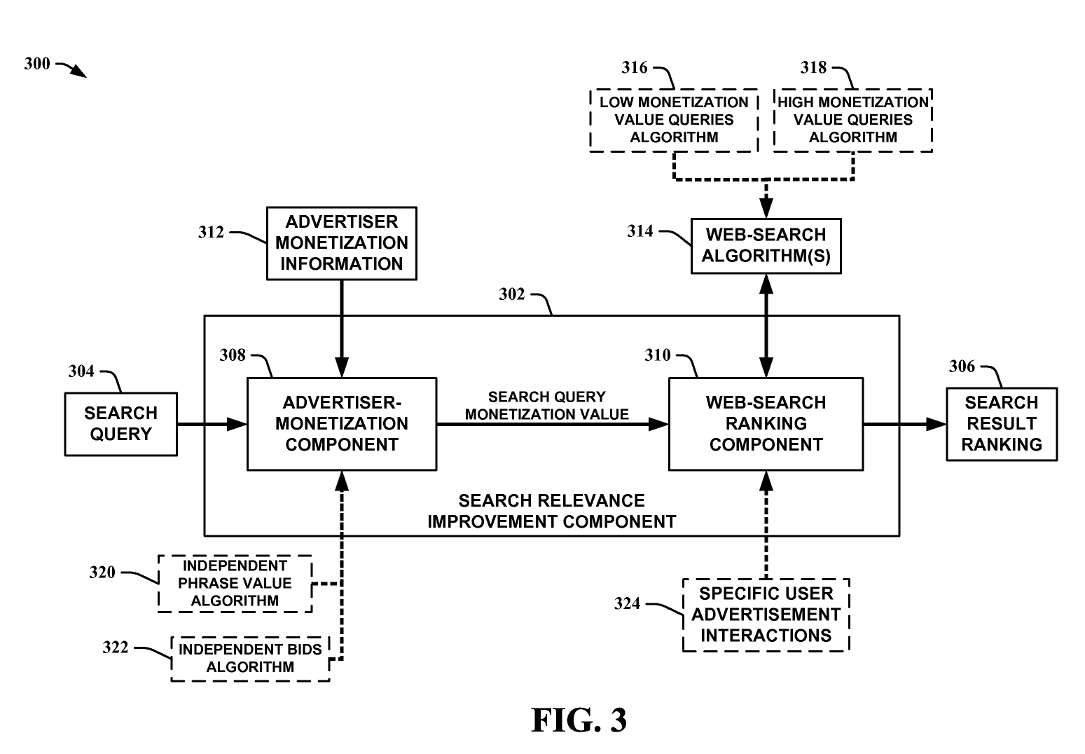

Referring to FIG. 3, a block diagram of a search relevance improvement system 300 in accordance with an aspect of an embodiment is illustrated. This instance executes in two parts—first, for a search query 304, an advertiser-monetization component 308 computes a monetization value using advertiser monetization information 312. Second, a web-search ranking component 310 uses the monetization value to decide how to rank results. For example, in one instance there can be two independent ranking algorithms available—one for high monetization queries and one for low monetization queries. In another instance, there can simply be a single ranking algorithm that takes as input the monetization value of the search query.

Thus, the search relevance improvement system 300 is comprised of a search relevance improvement component 302 that receives the search query 304 and provides search result ranking 306. The search relevance improvement component 302 is comprised of the advertiser-monetization component 308 and the web-search ranking component 310. The advertiser-monetization component 308 receives the search query 304 and the advertiser monetization information 312. A search query monetization value is then determined for the search query 304 based on, at least in part, the advertiser monetization information 312. To accomplish this, the advertiser-monetization component 308 can employ monetization value mapping techniques that utilize, for example, an independent phrase value algorithm 320 and/or an independent bids algorithm 322 and the like. It can be appreciated that the advertiser-monetization component 308 can employ many different monetization mapping techniques.

The web-search ranking component 310 obtains the search query monetization value from the advertiser-monetization component 308. In other instances, the web-search ranking component 310 can also obtain the search query 304 directly (e.g., directly from a search engine, advertising system, etc.). The web-search ranking component 310 employs web-search algorithm(s) 314 to facilitate in determining the search result ranking 306. The web-search algorithm(s) 314 are based on, at least in part, the search query monetization value determined by the advertiser-monetization component 308. For example, the web-search algorithm(s) 314 can include a low monetization value queries algorithm 316 and/or a high monetization value queries algorithm 318 and the like. It can be appreciated that there are many algorithms that can be employed with instances disclosed herein. Different algorithms can be employed by the web-search ranking component 310 to adequately weight the search query monetization values to improve search relevance.

The web-search ranking component 310 can also utilize specific user advertisement interactions 324 to facilitate in determining the search result ranking 306 for a specific user. The specific user advertisement interactions 324 includes, but is not limited to, clicking on advertisements, viewing advertisements, purchasing items through an advertisement, and other interaction activities (e.g., hovering a mouse pointer over an advertisement, prolonged eye contact (via eye movement detection devices), and/or attention (via environmentally aware devices) and the like). In general, the specific user advertisement interactions 324 are obtained from search engines and/or advertising systems which typically log information associated with user advertisement interactions. The information can also include, but is not limited to, levels of interaction such as looking but not clicking, clicking, and/or actually making purchases and the like related to an advertisement. Many search engines can also track individual users so these types of information can be user specific. In scenarios where a “user” is considered to be a specific computing entity (i.e., it could be shared by many different people), “user specific” refers to the computing entity when individual people utilizing the machine cannot be identified.

The specific user advertisement interactions 324 can be invaluable to user satisfaction during the determination of the search result ranking 306 by the web-search ranking component 310. Users who desire search results related to a likely spam topic will be dissatisfied if those topics are removed and/or downgraded in the search result ranking 306. Thus, by incorporating specific user advertisement interactions 324 into the search result ranking 306, the web-search ranking component 310 can provide tuned results for individual users, substantially increasing the user's satisfaction with the search result ranking 306.

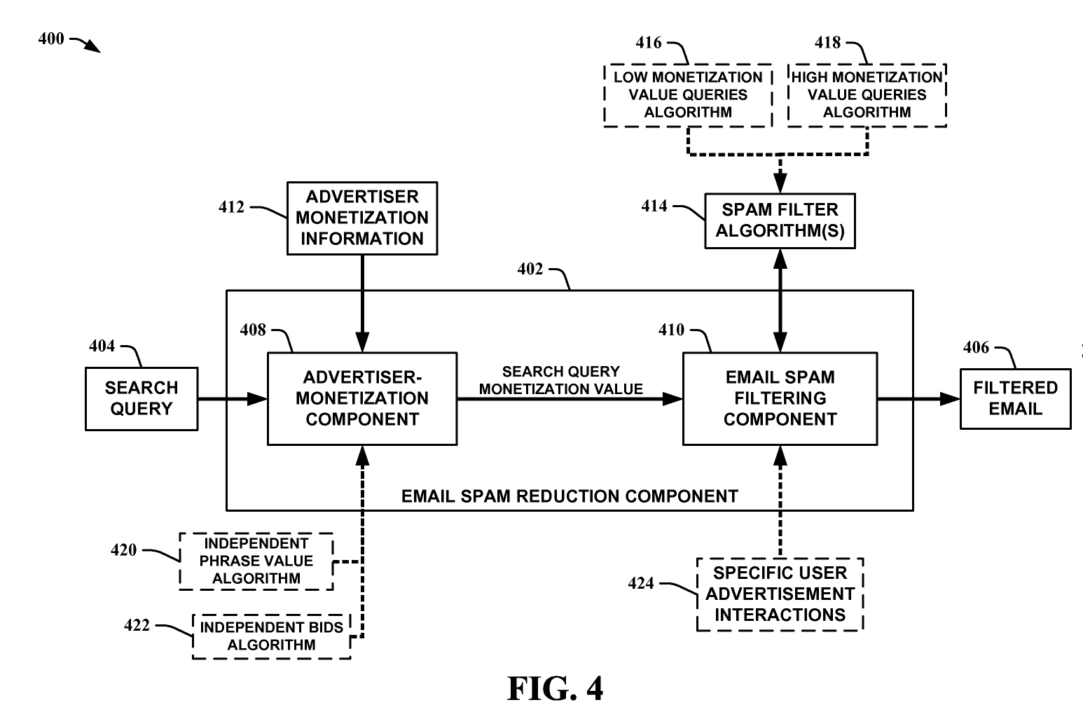

The monetization value from search advertisements can also be utilized to help detect email spam. The intuition is similar—if certain phrases such as “digital camera” are worth a lot to search advertisers, it might be expected that email spam will be sent from those same advertisers trying to sell users digital cameras. Thus, this can be leveraged to increase the effectiveness of a spam filtering. Looking at FIG. 4, a block diagram of an email spam reduction system 400 in accordance with an aspect of an embodiment is shown. The email spam reduction system 400 is comprised of an email spam reduction component 402 that receives a search query 404 and provides filtered email 406. The email spam reduction component 402 is comprised of an advertiser-monetization component 408 and an email spam filtering component 410.

The advertiser-monetization component 408 receives the search query 404 and advertiser monetization information 412. A search query monetization value is then determined for the search query 404 based on, at least in part, the advertiser monetization information 412. To accomplish this, the advertiser-monetization component 408 can employ monetization value mapping techniques that utilize, for example, independent phrase value algorithm 420 and/or independent bids algorithm 422 and the like. It can be appreciated that the advertiser-monetization component 408 can employ many different monetization mapping techniques.

The email spam filtering component 410 obtains the search query monetization value from the advertiser-monetization component 408. The email spam filtering component 410 employs spam filter algorithm(s) 414 to facilitate in determining the filtered email 406. The spam filter algorithm(s) 414 are based on, at least in part, the search query monetization value determined by the advertiser-monetization component 408. For example, the spam filter algorithm(s) 414 can include a low monetization value queries algorithm 416 and/or a high monetization value queries algorithm 418 and the like. It can be appreciated that there are many algorithms that can be employed with instances disclosed herein. Different algorithms can be employed by the email spam filtering component 410 to adequately weight the search query monetization values to improve email spam filtering.

The email spam filtering component 410 can also utilize specific user advertisement interactions 424 to facilitate in determining the filtered email 406 for a specific user. The specific user advertisement interactions 424 includes, but is not limited to, clicking on advertisements, viewing advertisements, purchasing through advertisements, and other interaction activities (e.g., hovering a mouse pointer over an advertisement, prolonged eye contact (via eye movement detection devices), and/or attention (via environmentally aware devices) and the like). In general, the specific user advertisement interactions 424 are obtained from search engines and/or advertisement systems which typically log information associated with user advertisement interactions. The information can include, but is not limited to, levels of interaction such as looking but not clicking, clicking, and/or actually making purchases and the like related to an advertisement. Many search engines can also track individual users so these types of information can be user specific. In scenarios where a “user” is considered to be a specific computing entity (i.e., it could be shared by many different people), “user specific” refers to the computing entity when individual people utilizing the machine cannot be identified.

The specific user advertisement interactions 424 can be invaluable to user satisfaction during the filtering of the filtered email 406 by the email spam filtering component 410. Users who desire to receive email related to a likely spam topic will be dissatisfied if those topics are removed and/or flagged in the filtered email 406. Thus, by incorporating specific user advertisement interactions 424 into the filtered email 406, the email spam filtering component 410 can provide tuned spam filtering for individual users, substantially increasing the user's satisfaction with the filtered email 406.

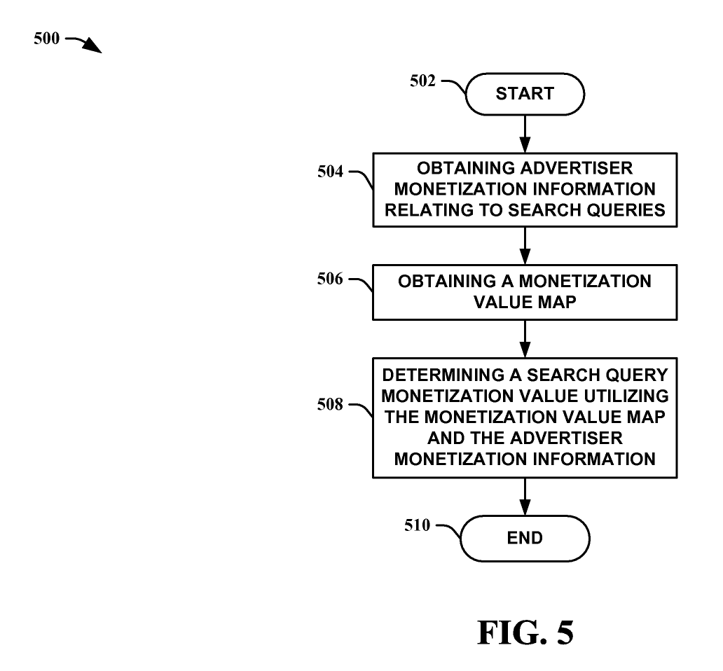

In view of the exemplary systems shown and described above, methodologies that may be implemented in accordance with the embodiments will be better appreciated with reference to the flow charts of FIGS. 5-7. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 5, a flow diagram of a method 500 of determining advertiser-monetization values for search queries in accordance with an aspect of an embodiment is depicted. The method 500 starts 502 by obtaining advertiser monetization information relating to search queries 504. The advertiser monetization information is typically collected from search engine and/or advertising system logs and can include, but is not limited to, such information as how many bidders were competing for a search query, what the bids were, and/or how much was charged and the like. A monetization value map is then obtained 506. The monetization value map is a process that generally includes a mapping algorithm such as, for example, an independent phrase value mapping algorithm and/or an independent bids mapping algorithm and the like. These example processes have been described in detail supra. However, the monetization value map is not limited to those two specific examples. Any process that can associate a value to search queries based on the advertiser monetization information can be employed. A search query monetization value is then determined utilizing the monetization value map and the advertiser monetization information 508, ending the flow 510. The determination of the search query monetization value can be a simple mapping utilizing a single algorithm and/or a complex mapping employing multiple algorithms. The flexibility of this process allows for tuning based on desired performance and/or available resources. After obtaining the search query monetization value, it can then be utilized in search relevance/ranking systems and/or spam filtering systems and the like.

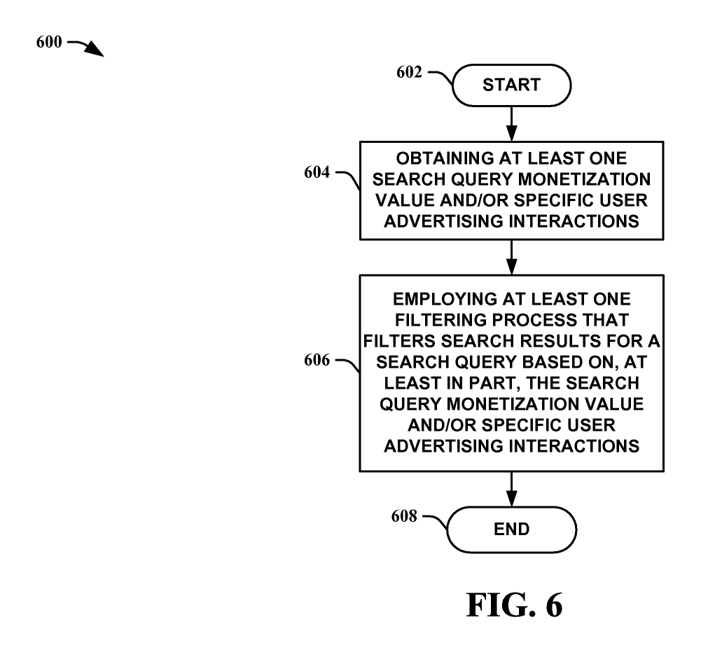

Turning to FIG. 6, a flow diagram of a method 600 of utilizing search query monetization values to improve search relevance in accordance with an aspect of an embodiment is illustrated. The method 600 starts 602 by obtaining at least one search query monetization value and/or specific user advertising interactions 604. The search query monetization value can be obtained from a monetization process such as the ones described above. The specific user advertisement interactions include, but are not limited to, clicking on advertisements, viewing advertisements, and other interaction activities (e.g., hovering a mouse pointer over an advertisement, prolonged eye contact (via eye movement detection devices), and/or attention (via environmentally aware devices) and the like).

In general, specific user advertisement interactions are obtained from search engines and/or advertising systems which typically log information associated with user advertisement interactions. The information can include, but is not limited to, levels of interaction such as looking but not clicking, clicking, and/or actually making purchases and the like related to an advertisement. Many search engines can also track individual users so these types of information can be user specific. In scenarios where a “user” is considered to be a specific computing entity (i.e., it could be shared by many different people), “user specific” refers to the computing entity when individual people utilizing the machine cannot be identified.

At least one filtering process is then employed that filters search results for a search query based on, at least in part, the search query monetization value and/or specific user advertising interactions 606, ending the flow 608. For example, a filtering process can include a low monetization value queries algorithm and/or a high monetization value queries algorithm and the like. The filtering process can also, for example, be utilized to provide ranking of the search results. It can be appreciated that there are many algorithms that can be employed with instances disclosed herein. Different algorithms can be employed to adequately weight the search query monetization values to improve search query filtering such as enhanced ranking/relevance. Use of specific user advertisement interactions can also be invaluable to user satisfaction during the search result filtering. For example, users who desire search results related to a likely spam topic will be dissatisfied if those topics are removed and/or downgraded in the search result filtering. Thus, by incorporating specific user advertisement interactions into the search result ranking, results can be tuned for individual users, substantially increasing the user's satisfaction with such filtering processes as search result ranking.

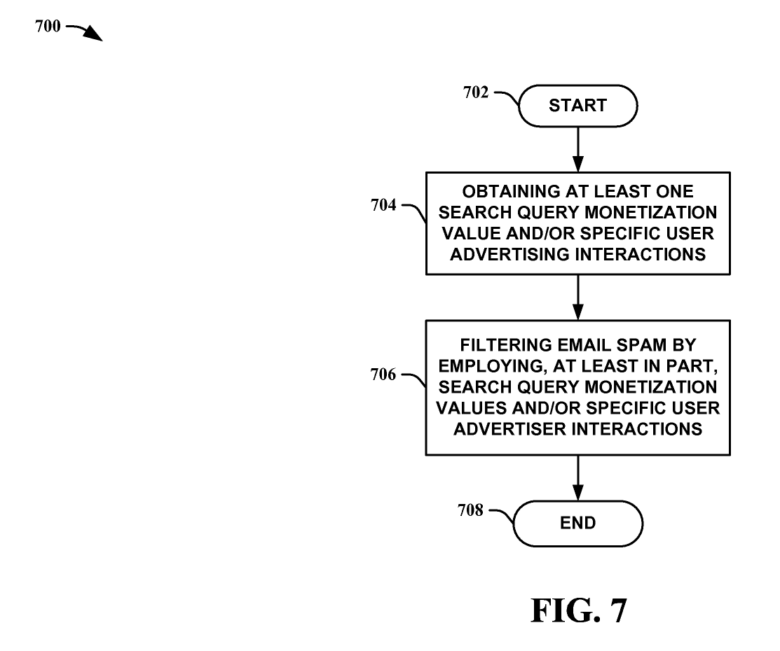

Referring to FIG. 7, a flow diagram of a method 700 of utilizing search query monetization values to filter spam emails in accordance with an aspect of an embodiment is shown. The method 700 starts 702 by obtaining at least one search query monetization value and/or specific user advertising interactions 704. The search query monetization value can be obtained from a monetization process such as the ones described above. The specific user advertisement interactions include, but are not limited to, clicking on advertisements, viewing advertisements, and other interaction activities (e.g., hovering a mouse pointer over an advertisement, prolonged eye contact (via eye movement detection devices), and/or attention (via environmentally aware devices) and the like).

In general, specific user advertisement interactions are obtained from search engines and/or advertising systems which typically log information associated with user advertisement interactions. The information can include, but is not limited to, levels of interaction such as looking but not clicking, clicking, and/or actually making purchases and the like related to an advertisement. Many search engines can also track individual users so these types of information can be user specific. In scenarios where a “user” is considered to be a specific computing entity (i.e., it could be shared by many different people), “user specific” refers to the computing entity when individual people utilizing the machine cannot be identified.

Email spam is then filtered by employing, at least in part, search query monetization values and/or specific user advertiser interactions 706, ending the flow 708. For example, a filtering process can include a low monetization value queries algorithm and/or a high monetization value queries algorithm and the like. It can be appreciated that there are many different algorithms that can be employed with instances disclosed herein. Different algorithms can be employed to adequately weight the search query monetization values to improve email spam filtering. Use of specific user advertisement interactions can also be invaluable to user satisfaction during the filtering of email. Users who desire to receive email related to a likely spam topic will be dissatisfied if those topics are removed and/or flagged. Thus, by incorporating specific user advertisement interactions into the filtering process, the spam filtering can be tuned for individual users, substantially increasing the user's satisfaction with the filtering process.

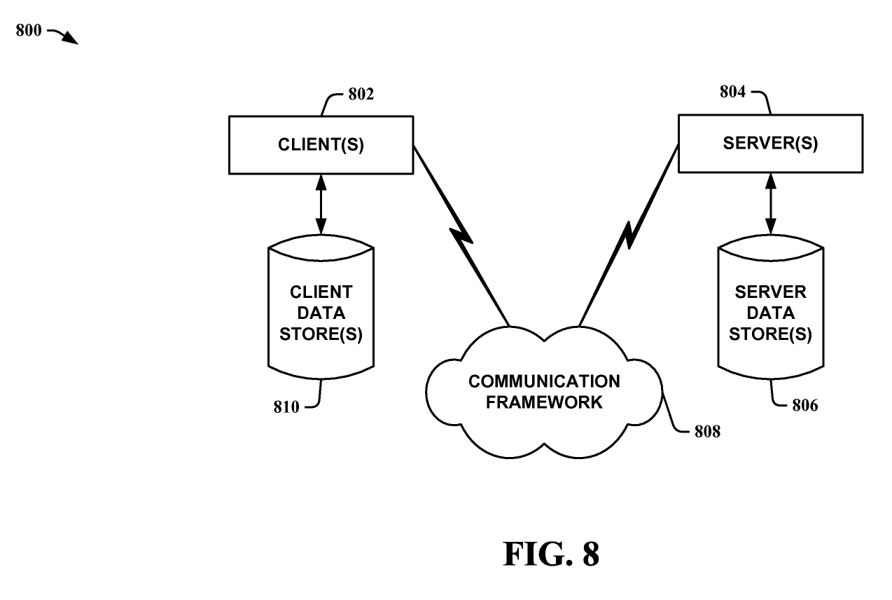

The various components and processes described above can reside in similar and/or disparate locations that require various communication means to retrieve/obtain information/data. FIG. 8 is a block diagram of a sample environment 800 with which embodiments can interact. The environment 800 further illustrates a system that includes one or more client(s) 802. The client(s) 802 can be hardware and/or software (e.g., threads, processes, computing devices). The environment 800 also includes one or more server(s) 804. The server(s) 804 can also be hardware and/or software (e.g., threads, processes, computing devices). One possible communication between a client 802 and a server 804 can be in the form of a data packet adapted to be transmitted between two or more computer processes. The environment 800 includes a communication framework 808 that can be employed to facilitate communications between the client(s) 802 and the server(s) 804. The client(s) 802 are connected to one or more client data store(s) 810 that can be employed to store information local to the client(s) 802. Similarly, the server(s) 804 are connected to one or more server data store(s) 806 that can be employed to store information local to the server(s) 804.

It is to be appreciated that the systems and/or methods of the embodiments can be utilized in search query monetization value facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that values search queries, comprising:
a receiving component that obtains advertiser monetization information and at least one search query from a user; and
an advertiser-monetization value component that determines a value for the search query based on, at least in part, the advertiser monetization information.

2. The system of claim 1, the advertiser-monetization value component utilizes independent phrase values and/or independent bids to facilitate determination of the search query monetization value.

3. The system of claim 1, the receiving component obtains the advertiser monetization information from a search engine and/or an advertising system.

4. The system of claim 1 further comprising:
a web-search ranking component that ranks search results based on, at least in part, the search query monetization value.

5. The system of claim 4, the web-search ranking component employs a low and/or high monetization value-based technique to determine search result ranking.

6. The system of claim 4, the web-search ranking component employs specific user advertisement interactions to facilitate determination of search result ranking.

7. The system of claim 1 further comprising:
an email spam filtering component that filters emails based on, at least in part, the search query monetization value.

8. The system of claim 7, the email spam filtering component employs specific user advertisement interactions to facilitate filtering of the emails.

9. A method for filtering organic search results, comprising:
obtaining advertiser monetization information relating to search queries;
determining a monetization value for a search query utilizing, at least in part, the advertising monetization information and a monetization value map; and
employing at least one filtering process that filters search results for the search query based on, at least in part, the search query monetization value.

10. The method of claim 9 further comprising:
employing specific user advertisement interactions to facilitate search result filtering.

11. The method of claim 9 further comprising:
utilizing the filtering process to rank the search results based on, at least in part, the search query monetization value.

12. The method of claim 9 further comprising:
employing specific user advertisement interactions to facilitate determination of search result ranking.

13. The method of claim 12 further comprising:
utilizing the specific user advertisement interactions to determine spam associated topics that are desirable to a specific user; and
including search results related to the desirable spam associated topics in the search result ranking.

14. The method of claim 9 further comprising:
utilizing a monetization value map based on, at least in part, an independent phrase value map and/or a map based on, at least in part, an independent bids map.

15. The method of claim 9 further comprising:
employing a single monetization value query process and/or low and/or high monetization value query processes for the filtering process.

16. A method for reducing email spam, comprising:
obtaining advertiser monetization information relating to search queries;
determining a monetization value for a search query utilizing, at least in part, the advertising monetization information and a monetization value map; and
filtering email spam by employing, at least in part, search query monetization values.

17. The method of claim 16 further comprising:
employing specific user advertisement interactions to facilitate email spam filtering.

18. The method of claim 17 further comprising:
utilizing the specific user advertisement interactions to determine spam associated topics that are desirable to a specific user; and
providing spam emails related to the desirable spam associated topics to the specific user.

19. The method of claim 16 further comprising:
utilizing a monetization value map based on, at least in part, an independent phrase value map and/or a map based on, at least in part, an independent bids map.

20. The method of claim 16 further comprising:
employing a single monetization value query process and/or low and/or high monetization value query processes for the ranking process.
